(19) United States
(12) Patent Application Publication
(10) Pub. No.: US 2022/0371637 A1
(43) Pub. Date: Nov. 24, 2022

(54) Lifting Device

(71) Applicant: Briscoe, Wallace, Inc., dba L. Wallace and Associates, Austin, TX (US)

(72) Inventors: Larry Wallace, Leander, TX (US); Leigh Briscoe, Austin, TX (US); Anthony Rodriguez, Austin, TX (US); Paden Hilborn, Austin, TX (US)

(21) Appl. No.: 17/664,170

(22) Filed: May 19, 2022

Related U.S. Application Data
(60) Provisional application No. 63/191,119, filed on May 20, 2021.

(51) Int. Cl. B62B 1/14; B66F 7/02

(52) U.S. Cl. CPC B62B 1/14; B66F 7/02; B62B 2203/10

(57) ABSTRACT

A lightweight, manually portable load carrying device with two wheels can raise and lower light to medium loads placed on its nose plate, using the torque of an electric motor. By this means, the traditional nose plate is used as a “lift plate,” and cargo can be raised or lowered to be placed in or taken out of motor vehicles, or onto and off of ledges, tables, counters or shelves, or any other elevated platform which would otherwise require manual lifting to reach.

### TECHNICAL FIELD OF THE INVENTION

The present invention relates to lifting devices, such as hand trucks.

### BACKGROUND OF THE INVENTION

Hand trucks, also referred to as dollies, are roughly L-shaped with a frame that has handles at one end, wheels at the base, and with a nose plate that extends away from the frame in a direction opposite to that of the wheels. A user sets objects on the nose plate, which rests roughly flat against the floor when the hand truck is upright. After placing a load onto the nose-plate, the user uses the frame as a lever and the wheels a fulcrum, lifting the nose plate. Hand trucks traditionally have a fixed nose-plate, allowing the operator to move objects horizontally along a surface, but require the operator to manually lift the object to place it on a higher surface (e.g., moving an object from the ground up and into the bed of a truck).

Many attempts have been made throughout the years to provide some kind of mechanized assistance to a hand truck user attempting to lift a load to a higher surface. These attempts have had limitations that have limited their usefulness. A problem frequently occurring in the prior art is that motors, lifting mechanisms, and power sources tend to make lift hand trucks significantly heavier than the commonly used portable hand-trucks. This additional weight significantly decreases the portability of the device.

Wesco Industrial Products, LLC of North Wales, Pa. sells a line of hand trucks having a hydraulic lift mechanism that are operated by a user manually pumping hydraulic fluid. https://catalog.wescomfg.com/viewitems/lift-equipment/steel-pedalifts-winch-hydraulic Such lifts require a significant effort by the user to raise a heavy load.

Another difficulty with providing a powered lifting nose plate on current hand-trucks is that most existing designs use the nose plate on which cargo is placed to support the hand truck, that is, as a third point of contact (in addition to the two wheels) with the ground when the user is supporting the hand truck. Lifting this plate off the ground in such a design causes it to fall forward. The Westco hydraulic lift hand trucks use distinct types of supports to maintain the lift hand truck in a vertical position when the nose plate is elevated, but the fitting together of the supports and the nose plate limits the designs of the nose plate and the supports, making the lift hand truck heavier and less portable.

### SUMMARY OF THE INVENTION

An object of the invention is to provide a portable lifting device with a powered lift-plate.

Some embodiments include electric motors with battery receptacles that are in a form factor compatible with off-the-shelf power tool rechargeable batteries. Some embodiments incorporate structural elements, referred to as “feet,” attached to the lifting device, so that when the lift plate is off the ground the lifting device is still able to stand up-right. Some embodiments include a passive slide system which can prevent the lift plate from moving during a mechanical failure or overload. Some embodiments facilitate the movement of the lift plate through the use of a single chain drive system.

The foregoing has outlined rather broadly the features and technical advantages of the present invention in order that the detailed description of the invention that follows may be better understood. Additional features and advantages of the invention will be described hereinafter. It should be appreciated by those skilled in the art that the conception and specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more thorough understanding of the present invention, and advantages thereof, reference is now made to the following descriptions taken in conjunction with the accompanying drawings, in which:

FIGS. 1A, 1B, and 1C show different views of a lifting device;

FIGS. 2A, 2B, and 2C show different views of the frame of the lifting device of FIGS. 1A-1C;

FIG. 3 shows a lift plate assembly of the lifting device of FIGS. 1A-1C;

FIG. 4 shows an exploded view of the slide mechanism of the lifting device of FIGS. 1A-1C;

FIG. 5 shows an exploded view of the slide mechanism of the lifting device of FIG. 4 from a different perspective;

FIGS. 6A-6C shows different views of the tension plate assembly of the slide mechanism of FIG. 4;

FIGS. 7A-7C show different views of components of the slide mechanism of FIG. 4.

FIG. 8 shows an exploded view of a portion of the portion of the slide mechanism of FIG. 4; and

FIG. 9 shows a system for retaining a load on a lifting device.

### DETAILED DESCRIPTION OF EMBODIMENTS

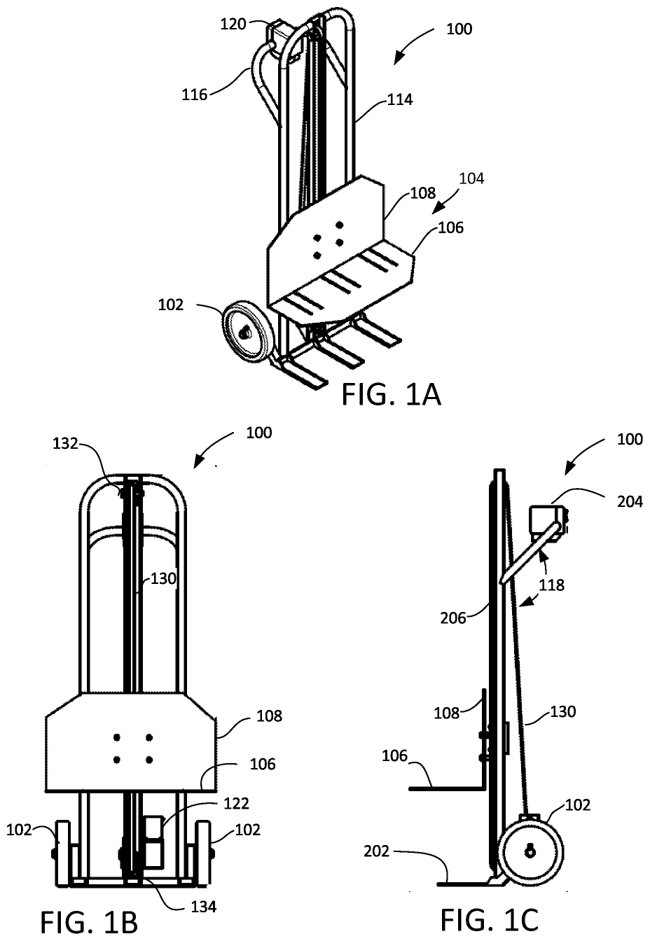

FIGS. 1A-1C show a lightweight, upright, manually portable lifting device 100 having two wheels 102. Portable lifting device 100 includes a nose plate assembly 104 that includes a nose plate 106 and a backing plate 108, the backing plate 108 connected to the nose plate 106 at an angle of approximately ninety degrees. Portable lifting device 100 can raise and lower light to medium loads placed on its nose plate 106. Embodiments can preferably raise and lower loads of up to about 60 pounds, about 80 pounds, about 100 pounds, about 120 pounds, or about 140 pounds. Nose plate 106 is used as a “lift plate,” and cargo can be raised or lowered to be placed in or taken out of motor vehicles, or onto and off of ledges, tables, counters or shelves, or any other elevated platform which would otherwise require manual lifting to reach.

Lifting device 100 includes a frame 114 and a handle 116. A battery and control switch 120 is mounted in the handle 116, and with wires snaked down the frame 114 to get to the motor within the gear motor assembly 122.

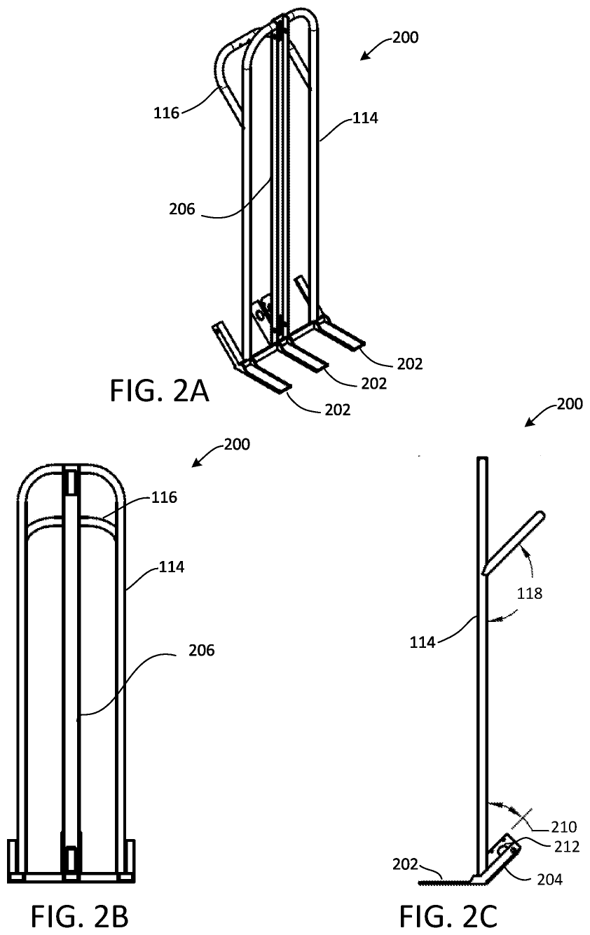

FIGS. 2A-2C shows a lifting device frame assembly 200 including the frame 114, the handle 116, multiple feet 202, a gear motor mounting bracket 204, a central channel 206, and two wheel-mounting brackets 208. The handle 116 is mounted at an angle 118, preferably about 135 degrees, from the frame 114. Gear motor assembly 122 (FIG. 1) is attached to a bracket 204 on the rear of the lifting device, the bracket mounted at an angle 210, preferably about 45 degrees. The gear motor assembly 122 in some embodiments uses a power drill-style torque clutch to prevent overloading and other misuse malfunctions.

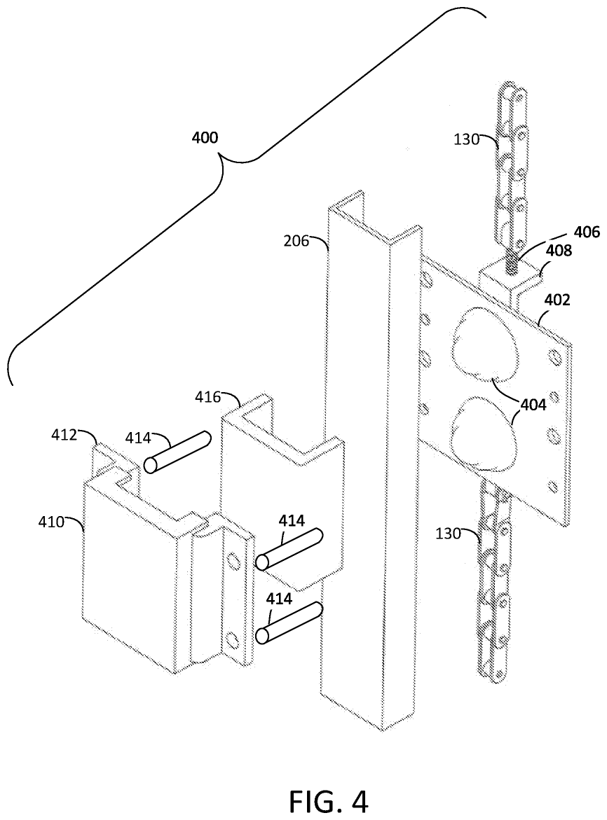

The gear motor assembly 122 turns a drive shaft that runs through a hole 212 in bracket 204. A fixed sprocket (behind wheel in FIG. 1C) mounted on the shaft drives a chain 130. Chain 130 runs on a top idler gear 132 and a bottom idler gear 134. FIG. 1C shows the routing of the chain 130. Chain 130 connects to nose plate assembly 104 through a slider system described below and shown in FIGS. 4-8, in which a tension plate is bolted to the lift plate assembly. Polypropylene or other thermoplastic spacers over the aforementioned bolts act as heavy, short-throw compression springs, and the steel plate itself has the flex to distribute the clamp load evenly and prevent galling without the use of exotic low-friction materials. The tension plate has captive ball bearings on the back and is bolted to a piece of channel which fits over the central channel 206 and makes contact with it through a channel nylon spacer.

Lifting device assembly 100 is “manually portable,” that is, it is sufficiently light weight that an average healthy man or woman could pick up the lifting device without mechanical assistance, or the assistance of other persons, and place it into a car, truck, or other transportation device. In some embodiments, the lifting device weighs less than about 50 pounds, less than about 40 pounds, less than about 35 pounds, or more preferably less than or equal to about 30 pounds. For example, in one embodiment, a lifting device weighing less than about 30 pounds can raise and lower a load of up to about 120 pounds.

Existing hand truck designs use the nose plate on which cargo is placed as a third point of contact with the ground when the user is not holding it. Lifting this plate off the ground in such a design would cause it to fall forward. Lifting device 100 includes a means of preventing the lifting device from tipping forward when loads are raised, without interfering with the operation of the lifting device. An additional structural element or elements, such as a number of feet 202, can be added to prevent tipping.

In some embodiments, the feet and lift plate preferably satisfy multiple conditions. First, the feet are constructed in such a way as to allow the top surface of the lift plate to be sufficiently close to the ground that a user can slide the lift plate under a load. Otherwise, the lifting device is likely limited to moving objects which can be lifted and placed on the lift plate by the user. In some embodiments, the top of the lift plate is within 3/16″ of the ground when the lifting device is upright. the feet described herein accomplish this by having an average height that falls below about 3/16″ or below about 0.1937″, which is approximately 9/64″.

Slots and/or rolls can be formed in a lift plate, so as to allow it to clear the feet and reach near to the ground when lowered onto feet or other supporting members. Although slots in the lift plate can be used to accommodate the feet so that the lift plate can get closer to the ground without being impeded by the feet. The second condition is that the slots should not be so large or so shaped that they significantly weaken the lift plate. The feet preferably do not occupy space at the base of the lifting device that would require the plate to be bisected or otherwise have large gaps, that is, gaps greater than approximately 4 square inches. This design permits a strong yet lightweight lift plate, keeping the overall weight of the lifting device low. In other embodiments, the feet occupy less than about 6 sq inches, less than about 5 sq inches, less than about 4 sq inches, or less than about 3 sq inches. In general, such bisection or large gaps could reduce the lifting device's utility by requiring that the load be larger, lighter, and more solid than it would be without the bisection or large gaps. The feet in some embodiments are designed to have a maximum height of about ¼″ over areas of less than about 4 square inches each. The feet are shorter in length than the lift plate, and therefore do not bisect it or otherwise require the lift plate to be divided and discontinuous along the front edge. In the prior art, which uses a traditional nose plate, slots or rolls in the nose plate normally exist only to lighten or to strengthen the plate. In some embodiments, there is an element which combines with the feet to allow for a freestanding, lifting device which retains its full usability as a hand truck rather than being restricted to use as a lifting device alone.

The third preferred condition is that the feet are preferably light enough so that the net weight of the lifting device does not exceed the expected comfortable lifting capacity of the user. The feet are also strong enough to resist without significant deflection caused by the stress on the lifting device when the lifting device is loaded to its working load limit and the leverage action of the nose plate against the feet. Excessive deflection of the feet may cause the cargo to slide off the plate as the lifting device pitches. In one embodiment, the feet are ⅛″ thick but have two vertical ⅛″ thick ridges on the left and right sides (making them, technically, u-channel) which fit into slots in the nose plate 106 (rolls could also be used to make the lift plate fit over the feet and would strengthen it.) The nose plate is several inches wider and deeper than the feet to make it ergonomically infeasible to trap feet and other body parts between the lift plate and feet while operating it. Limit switches can be used to further prevent this, but the Applicant's experience has been that the torque clutch engages before anything manages to pinch a user too hard.

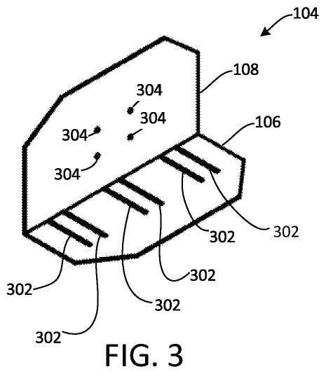

In some embodiments the feet are designed as an array of three feet with two ¼″ ridges on each foot. This configuration has been found to provide enough strength to prevent pitching of the lifting device when loaded. The ridges in this embodiment are also narrow enough (about ⅛″) to sit in slots or rolls in the lift plate when it is fully lowered, without significantly reducing the strength of the lift plate. FIG. 3 shows an embodiment of a lift plate assembly 104 in which the lift plate 106 has ridges 302 for accommodating the feet 202 under the lift plate. FIG. 3 also shows four holes 304 in backing plate 108 that are used to attach backing plate 108 to tension plate 402.

A method and system for providing power to the electric motor of the lifting device without the use of a power cord is provided. A hand truck that must remain tethered to a wall outlet would be of little use. Instead, an electric battery may be used to provide power to the motor. While an internal rechargeable battery can be used, such a choice of battery has the disadvantages of needing an AC adapter to be carried with the lifting device. Furthermore, if the battery is drained while in use (e.g., during moving one's place of dwelling) then the lifting device is subject to downtime while it charges. Disposable batteries can be used as well, but the power requirements of a medium duty lifting device would necessitate a great many of them and would drain them quickly, making its operation expensive and increasing its weight. Instead, in some embodiment, portable power tool batteries are used, allowing the user to swap batteries immediately when one is drained, and to leave the drained battery in a charger. Furthermore, by maintaining compatibility with one or more types of commercially available tool batteries, users who already own batteries of an appropriate type may use them with the lifting device, rather than needing to purchase additional batteries and/or chargers to use with it. Commercially available tool batteries may be, for example, batteries from cordless drills, lawnmowers, chainsaws, etc.

In some embodiments, the battery receptacle at battery and control switch 120 connected to the electric motor takes a common brand of power tool battery, and others may be used with an adapter (given appropriate voltage.) In one such embodiment there are four wires (the “up” circuit and the “down” circuit) coming out of the box and into the horizontal d-handle pass through a hole in the center of the handle, around to the vertical section of conduit, down to the base of the frame, out a hole in the conduit on the side where the motor is mounted, and are soldered to opposing poles on the motor, completing the circuits.

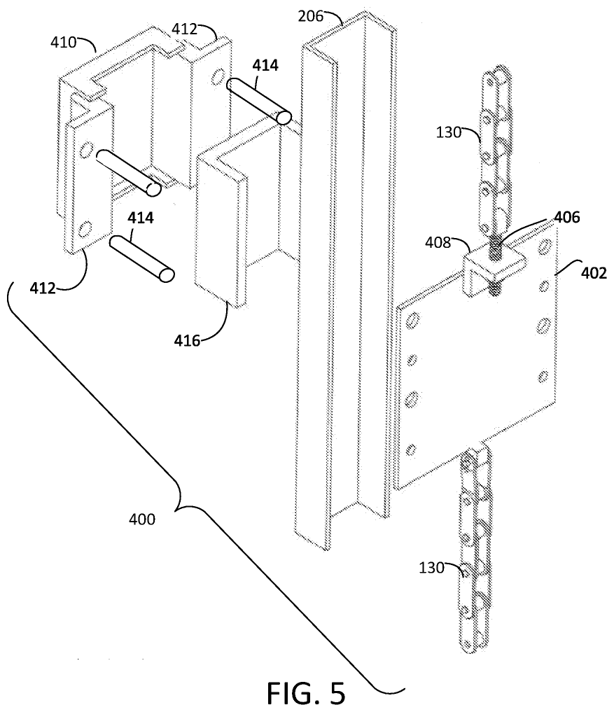

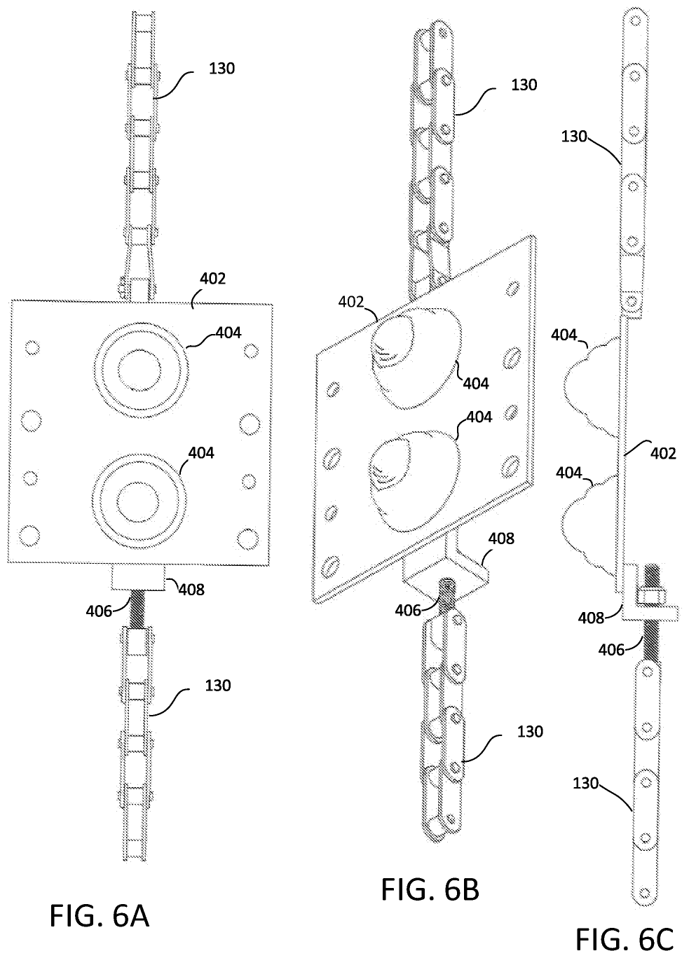

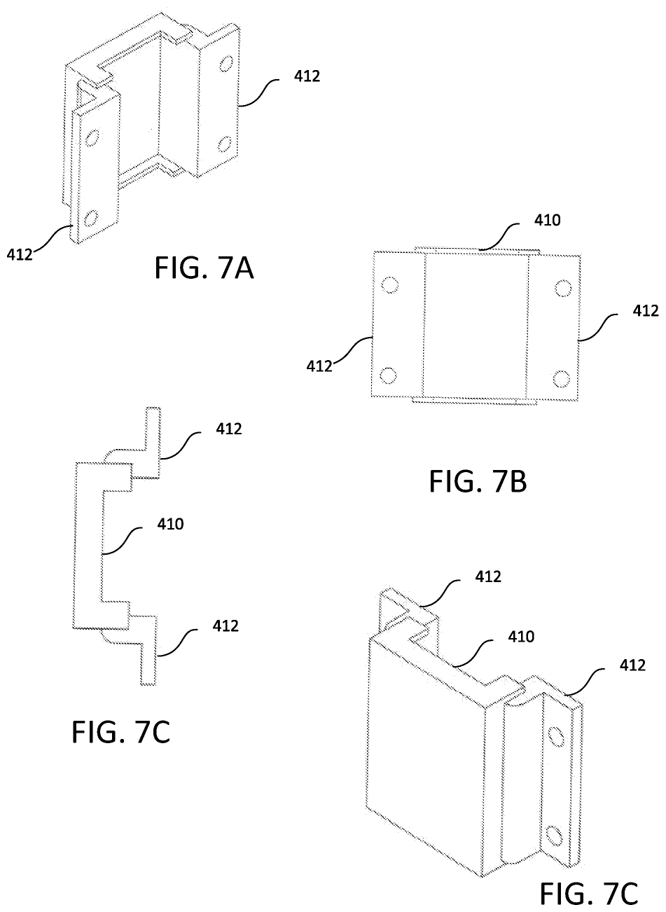

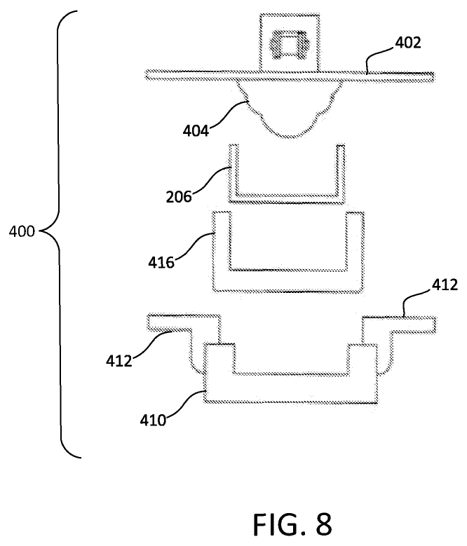

For the user's safety, the lifting device should prevent loads from moving the lifting plate when the lifting device is overloaded or experiences a mechanical failure. FIGS. 4-8 show a slide assembly 400 and components thereof that are incorporated as a load handling system. FIGS. 4 and 5 show exploded views of the slide mechanism from different perspective. FIGS. 6A-6C shows different views of the tension plate assembly of the slide mechanism. FIGS. 7A-7C show different views of components of the slide mechanism of FIG. 4 and FIG. 8 shows an exploded view of a portion of the portion of the slide mechanism.

At both ends of the chain 130, a ⅛″ thick square steel tension plate 402 is connected by attachment mechanism 406 to chain links on the top and bottom (only top attachment point visible in FIGS. 4 and 5). Attachment mechanism 406 attaches to a bracket 408 attached to the tension plate 402, the bracket including a hole to accommodate a bolt which is secured to the chain link at the chain end and is maintained in the bracket 408 by a nut. Two 1″ captive ball bearings 404, each comprising a hemispherical race using the one-inch ball rolling against dozens of 1/16″ balls in a lubricated enclosure, are welded to the rear face of the tension plate 402 (they could also be bolted, riveted, pinned, or even epoxied on, but welding reduces the size and weight of the assembly). The tension plate 402 is bolted with nuts (not shown) to the rear of a section of a larger channel 410 via holes in two pieces of ¼″ angle aluminum 412 welded to the outside of the front (open end) of the legs of said larger channel 410. Encasing the four bolts, between the steel plate and the front of the welded angle aluminum, are four tubular polypropylene spacers 414 which act as compression springs when the bolts are tightened. A nylon spacer 416, shaped like u-channel, occupies the space between the larger section of u-channel and the smaller u-shaped central channel 206 that makes up the center member of the frame. The nylon spacer 416 is captured in the large channel 410 by welded end caps with cutouts 1/16″ smaller than the spacer. The backing plate 108 of lift plate assembly 104 is mounted to the tension plate 402 by hex screws, nuts and fender washers (to prevent deformation of the aluminum under uneven loads.)

When the above assembly is tightened, spring tension on the ⅛″ steel plate and on the polypropylene spacers reaches equilibrium, and both the nylon spacer and the captive ball bearings make contact with the center channel of the frame at the same time. This hybrid slide-roller prevents pitching, rolling and yawing of the lift plate while the motor is applying torque. However, when the motor is stopped, the mechanism pitches forward proportionally to the load applied to the lift plate. The added friction assists the brake mechanism in holding loads in place while not powered and can even lock up in the event that a severe overload occurs which would otherwise overcome the brake or sever the drive train.

The slide assembly offers three distinct advantages over a conventional load handling system, such as a guide rod and bushing. First, by adjusting the pressure between the tension plate and the large channel 410, an even load distribution on the center channel is achieved when the slide assembly is pulled via the chain attachments on the mounting plate.

Second, when the chain is not pulling the tension plate, it functions in the opposite manner, meaning that cargo on the lift plate is not at risk of dangerous free-fall should the chain, drive train or chain tension screw fail. When levered from the lift plate, rather than pulled by the chain attachments on the tension plate, the slide assembly pitches slightly. This lifts one captive bearing (alternatively, roller) away from the channel, increasing its friction as the load doubles. The same pitching action decreases the contact area between the slide insert and central channel 206, similarly, increasing friction above the intended operating value as set by the tension on the assembly. The result of this feature is to gall the slide system to a stop in the event of a mechanical failure, or an overload caused by shock loading which would otherwise overcome the brake (e.g., a heavy load bouncing on the plate while the lifting device is in motion, or the load tipping over and falling onto the plate while the user is loading the lifting device.)

By this method of increasing friction in the slide assembly when the force on the slide is delivered by a load on the lift plate, rather than by the chain via the motor, the drive train and motor brake can be made lighter, while simultaneously increasing safety in the event of a mechanical failure. Moreover, this increase in operator safety eliminates the need for heavy and cumbersome guards at the base of the lifting device, and for failure-prone safety catches. These advantages contribute to the small size and low weight of the lifting device, increasing its range of uses and convenience to the user.

The above component serves an additional purpose, which is to facilitate the use of a central drive system. Chains and sprockets are heavy components, and the low-clearance, tension-calibrated slide allows the lift plate to be pulled from a central member rather than from two or more members which would mean adding a large portion of redundant drive train. Instead, the yaw and roll restriction offered by the slide assembly allows the use of only a single set of chains and sprockets, thereby decreasing the cost and weight considerably. Without it, a roller chain in many situations would be an impractically heavy and expensive drive mechanism for the purpose, and several other drive mechanisms explored in research and development proved either too expensive or mechanically inadequate.

Some embodiments use a DC motor with outputs to a d-cut shaft driving the first sun gear of a three layer planetary gearbox which applies torque to a torque clutch. The torque clutch transfers power to a chuck, unless an operator attempts to lift weights in excess of the machine's rated capacity or to drive the carriage against the top and bottom of the traverse (in which case it disconnects until the load is reduced.) The chuck holds a keyed shaft which drives the input of a worm gear reducer. The DC motor and the orbital gearbox are mounted to the top of the worm gear reducer's housing via an armature. The worm gear reducer is mounted by the side to a bracket. This bracket is attached to the rear of the central channel 206 of the frame. A hole in each side of this bracket passes the driveshaft for the chain drive. The driveshaft is pinned to the output shaft of the worm gear reducer.

This shaft spins in two flanged, oil-impregnated bronze bushings and is retained where it exits the bracket via a cotter key and washer. A #40 (half inch pitch) roller chain sprocket is attached to the middle of the driveshaft with a set screw, so that it turns with the drive shaft. As the drive sprocket turns with the shaft, it pulls a chain (˜7.5 ft of #2040 2×½″ pitch chain) which is looped around an idler sprocket (a sprocket with no key or set screw, but rather one that turns on a fixed circular bearing race in the bore) at the top and bottom of the frame. Those two idler sprockets spin free on bolts which are fitted through smooth holes at the top and bottom of the center c-channel section of the frame. These vertically aligned idlers cause the chain to self-center when moved.

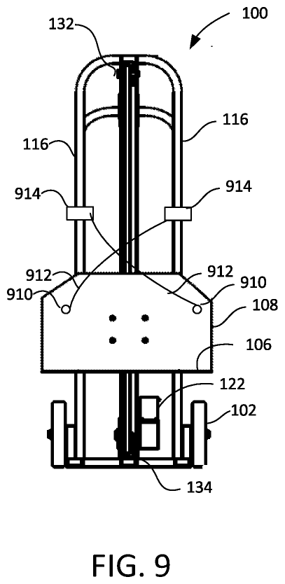

FIG. 9 shows a system for retaining cargo which can be top-heavy, unbalanced, or larger than the lift plate, without restraining the lifting device's lifting ability. On a traditional hand truck, straps, bungees or other tie-down devices can be used to hold cargo in place by securing it to the frame. When a lift plate is employed, however, attaching straps directly to the frame would inhibit or prevent its movement, reducing the utility of the hand truck and potentially damaging the mechanism. To solve this, in the embodiment shown in FIG. 9, the nose plate 106 or backing plate 108 includes attachment points, such as holes 910, for hooks so that cargo retention devices such as straps 914 and bungees can be applied to any loads which are not stable as-is. In order to preserve the mobility of the lift plate when a load is retained in this way, two or more wire loops 912 with rollers hang on each of the two vertical tubular sections. When cargo retainers are applied to them, the rollers ride along the tubulars, preventing the load from falling while simultaneously allowing the lift plate to traverse in a way that it would not if the retainers were attached to a non-mobile frame element at one or both ends.

The tubular supports described above stabilize the center channel. These are comprised of two pieces of 1″ dia.×⅛″ thick aluminum round tube welded at the angle aluminum that makes up the base of the frame, and at the top of the center u-channel after making 90-degree, 3.5″ center-line-radius bends toward the channel. A u-shaped piece of the same conduit, coped and welded to the two vertical pieces of conduit about a quarter of the way from the top, forms a horizontal d-handle. A box is mounted to the d-handle which contains the battery socket, and a momentary-on, momentary-off rocker switch.

Although the present invention and its advantages have been described in detail, it should be understood that various changes, substitutions and alterations can be made herein without departing from the spirit and scope of the invention as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

We claim as follows:

1. A motorized lifting device comprising:
a frame having a bottom end;
two wheels rotationally attached to the bottom end of the frame;
a lift plate attached to the frame in a manner that permits the lift plate to be raised or lowered;
one or more feet each attached to the bottom of the frame in a manner that does not obstruct the rotation of the two or more wheels; and
a motor attached to the lift plate through a drive system such that the motor can raise or lower the nose plate, such that when the lift plate is raised, the motorized lifting device is prevented by the feet from falling forward as the lift plate is raised off the ground.

2. The motorized lifting device of claim 1 in which the top of the lift plate at the front of the lift plate rests within 3/16″ of the ground when the lifting device is upright.

3. The motorized lifting device of claim 1 in which the feet do not extend further from the frame than the lift plate extends.

4. (canceled)

5. (canceled)

6. (canceled)

7. The motorized lifting device of claim 1 in which the lift plate includes a distal end farthest from the frame and in which the distal end lacks cuts towards the frame.

8. The motorized lifting device of claim 6 in which the ridges on each foot have a height of less than ¼ inches and the ridges on each foot comprise an area of less than 4 square inches.

9. The motorized lifting device of claim 1 in which the lift plate includes recesses for accommodating the feet, such that when the lift plate is lowered, the feet recess into the recesses, allowing the lift plate to get closer to the ground.

10. A motorized lifting device comprising:
a frame having a bottom end;
two or more wheels rotationally attached to the bottom end of the frame;
a lift plate attached to the frame, the lift plate attaches in a manner that permits it to be raised or lowered on the frame;
an electric motor attached to the lift plate through a drive system such that the motor can raise or lower the lift plate; and
a receptable configured to accept a removable, rechargeable battery pack to power the electric motor.

11. The motorized lifting device of claim 10 in which the receptable accepts a removable, rechargeable battery pack configured to be accepted by a commercial tools of a portable tool line.

12. The motorized lifting device of claim 10 wherein the two wheels rotationally attached to the bottom of the frame are not motorized.

13. A motorized lifting device comprising:
a frame having a bottom end;
two or more wheels rotationally attached to the bottom end of the frame;
a lift plate attached to the frame in a manner that permits the lift plate to be raised or lowered on the frame;
a motor attached to the lift plate through a drive system such that the motor can raise or lower the lift plate; and
a slide assembly configured to prevent the lift plate from moving when overloaded or suffering a mechanical failure.

14. The motorized lifting device of claim 13 in which the slide assembly is configured to passively prevent the lift plate from moving when overloaded or suffering a mechanical failure.

15. The motorized lifting device of claim 14 in which the slide assembly is balanced when there is a load on the chain supporting the lift plate and the slide assembly becomes unbalanced when there is no load on the chain or when the load on the chain is above a specified maximum load.

16. The motorized lifting device of claim 14 in which the friction of the slide assembly is increased in the slide assembly when the force on the slide is delivered by a load on the lift plate, rather than by the chain via the motor, the drive train and motor brake.

17. The motorized lifting device of claim 13 in which the slide assembly comprises a mounting plate and a slide cup such that the load is evenly distributed on the center channel when the slide assembly is pulled by a chain attached to the mounting plate.

18. The motorized lifting device of claim 17 in which when the chain is not pulling the lift plate, the slide assembly pitches, galling the slide system to a stop.

19. The motorized lifting device of claim 13 wherein the motorized lifting device further comprises a cargo retention device that stabilizes and secures the load on the lift plate that without restricting the motion of the lift plate.

20. The motorized lifting device of claim 19 in which the cargo retention device comprises straps that raise and lower as the lift plate raises and lowers.

21. The motorized lifting device of claim 19 in which the cargo retention device comprises:
two or more wire loops with rollers attached to the frame;
a tie-down device configured to be attached to the two or more wire loops and the lift plate at the same time.

22. The motorized lifting device of 21 in which the two or more wire loops have rollers that are positioned around the outer members of the frame.

23-29. (canceled)

30. The motorized lifting device of claim 13 wherein the slide assembly prevents the lift plate from moving via a passive system which stops the slide.

31. The motorized lifting device of claim 13 wherein the slide assembly prevents the lift plate from moving by means of friction.

32. The motorized lifting device of claim 1 in which the feet are ⅛″ or less thick.

33. The motorized lifting device of claim 1 in which the lift plate has slots or rolls so as to allow it to reach near enough to the ground when lowered onto the feet.

34. The motorized lifting device of claim 1 in which each of the feet has ridges to provide strength.
